(19) United States
(12) Patent Application Publication
(10) Pub. No.: US 2012/0224504 A1
(43) Pub. Date: Sep. 6, 2012

(54) ALTERNATE STRUCTURE WITH IMPROVED TECHNOLOGIES FOR COMPUTER COMMUNICATION AND DATA TRANSFERS

(76) Inventor: Parthasarathy Ramasamy, Chennai (IN)

(21) Appl. No.: 13/261,288

(22) PCT Filed: Jul. 15, 2010
(86) PCT No.: PCT/IN2010/000475

§ 371 Date: May 9, 2012

(30) Foreign Application Priority Data
Mar. 4, 2010 (IN) 562/CHE/2010

(51) Int. Cl. H04L 12/56

(52) U.S. Cl. 370/254

(57) ABSTRACT

The computer communications and data transfers in the prior art depend on costly networks and internetworks, also on the problematic and defective addressing systems and further on the time consuming elaborate intelligent routing table look-up-mapping procedure and still further on the advantageous method for source or explicit routing getting sadly confined to communications within specialized single costly network like ATM, MPLS, etc., and not being extended for end user-to-end user communications. These problems are solved by evolving an alternate structure for communications without the use of any network and based on an inexhaustible device-attached permanent addressing system, and more importantly, this system exhibiting totally blemish-less or accusation free delivery to the addressee proper. The alternate structure takes into cognizance the geographical locations of computer devices which form the basis for end user-to-end user recorded dedicated circuit connected paths and the associated improved technologies emerging there-from such as Global Communication topology (GCT), Access Provider Exchanges (APEs), Strict Prescribed Path (SPPs), Global Strict Prescribed Path Address Directory (GSPPAD), and Route Indicators (RINDs). The resulting routing/switching method and header/frame devices Data Route Compact (DRC) are getting suitably improved to achieve high speed worriless communication.

### 1 BACKGROUND OF THE INVENTION

### 1.1 Nature of The Invention

1.1.a Field of the Invention

The present invention relates to computer communications and data transfers and in particular is for evolving an alternate structure for electronic digital communications and data transfers through computers by incorporating improved technologies in the field of addressing, tracing computer/LAN locations, configured/recorded paths, source routing/circuit switching, and frame format.

1.1.b Use of the Invention

The invention has developed an alternate structure to the prior art structure for computer communications and data transfers; the latter structure is fully adopting the concept and requirement of networks carrying communications in, through or over them. But the structure evolved in this invention is used for not relying on any kind of network for effecting communications and for the identification and figuring out of the geographical location of all the computing devices either being alone or connected in a LAN, besides enabling to fix dedicated end user to end user communication without any prior exploration in advance, and facilitating a secured communication and high speed data transfer through improved technologies.

### 1.2 Prior Art

1.2.a. Background and Present State of the Art

Electronic digital communication system, through switch based connection oriented (CO) or router related connectionless (CL) transmitting network or network of networks (Internet), makes possible a computer on a network to correspond with another one in any network by sending information in discrete digital lumps in a continuous or discontinuous stream of bits.

A Local Area Network (LAN) is a system in which two or more devices are connected together through wires or cables or even wirelessly for information exchange and sharing of resources using communication technologies at layer 2 and having layer 2 connecting devices with no routing at layer 3. Two or more LAN segments connected together using layer 3 connecting devices would still be a LAN. Important technologies used in LAN environment are Ethernet, Token Ring, and FDDI etc. Carrier Sense with Multiple Access and Collision Detection—CSMA/CD—access method is used by Ethernet. Passing a Token around the network ring, seizing it by a connected computer, changing its status to busy, inserting data on to the network and releasing the token is the access method used by the Token Ring technology.

Two or more LAN's connected together through wide area network devices and technologies over a large geographical area by private or leased communication lines are known as Wide Area Networks (WANs). Notable technologies required for forming WANs are Frame Relay, T.I Lines, Integrated Service Digital Networks (ISDN) and Digital Subscriber Line (DSL). Individual LAN Segments of a WAN is provided with wired connectivity and an end point connectivity like router, bridge, access server or other form of Data Terminal Equipment (DTE). In-between DTEs of two LAN Components of a WAN, Channel Service Unit/Digital Service Unit (CSU/DSU) are used if a carrier is needed; but if an Internet is availed CSU/DSU or any other device is not needed. Frame Relay uses Virtual Circuit with Data Link Connection Identifiers (DLCIs) and Link Access Procedure Balanced (LAPB) address mechanism.

Two inter-connected communicating network constitute internet. Most not all internets are called Internet (upper case I) which is a worldwide collection of global public computer networks, hundreds of thousands of them interconnected together and built mostly around the TCP/IP suite of protocols. It is structured and organised communication system. Though, there are quite a few network protocols like IBM SNA, IPX/SPX, etc, TCP/IP has become the communication language of the network. Transport layer and Network layer protocols with Transport Gateway as well as routers and packet switching connecting devices enable the packets to be moved between remote networks in internet working technology. Intelligent routers are the backbones of Internets.

In PSTN networks in ‘circuit Switching’, dedicated fixed bandwidth non shareable channel is established from source to destination after reserving resources by the call set-up process, information transfer as bit streams is commenced through CO service and at the end call termination takes place. In Ethernet computer networks in ‘Packet Switching’, digital data lumps called packets are created by a computer; Medium Access Control (MAC) addresses are furnished and a request is made to the network to deliver it through CL service. In ATM or B-ISDN networks through ‘Virtual Circuit Switching’, the computer informs the network the kind of digital data it wants to send to the destination address and also specifies the quality of service (QoS) needed in the initial negotiation phase. After deciding that it can meet-the service demanded, the network tells the computer that a connection has been arranged with the destination and data packet transfer through explicit path routing can begin through CO service.

Historically, IP service enabled internetworking to be achieved in spite of such variations in constituent networks of internets. The internetworking architecture is so openly evolved that while networks are free internally to do whatever and however they desired, they have to abide by certain rules if they wanted to have interconnection and work with other networks. An information package cannot be simply taken from one type of network and thrown into another type. Skilful transformations are required to be made through convergence brought about by an abstract service which could provide convergence function for implementing itself in each and every kind of technology based networks. Thus all networks are made to look the same by this process thereby solving interconnection problem to a great extent. The Internet Protocol (IP) Service furnishes such convergence function to almost all networking technologies.

End-to-end transparency, packets, addresses and routers are the essential characteristics required for effective internet communications. End-to-end transparency requires information may flow from source to destination essentially unaltered. Packeting, addressing, and routing, also need special considerations.

Packets called datagrams, frames, cells etc are used to send digital information through headers and payload, the former carrying, inter alia, address details facilitating routing decisions and the latter carrying actual user information. Application layers' prepared ‘message’ is converted into a ‘segment’ by TCP adding control functions therein. This is transformed as a ‘datagram’ by IP furnishing IP addresses. The data link layer converts it into ‘frame’ incorporating physical addresses and checksum

The IP header contains the IP addresses which are looked into by the routers and hosts to move packets between networks. This address is divided into two portions: the left portion is the ‘network prefix’ and the right portion the ‘interface prefix’. (It is a misnomer to call the latter as host id). Data layer header contains the physical address for moving packets within a network. The IP devices such as the routers will not look into and perform any function relating to their physical addresses. Likewise, the link layer devices and technologies will not understand the IP addresses and take any action on them.

In the IPv4 addressing system, four discrete octal numbers each having a decimal value varying from 0 to 255 are used with three dots separating them. 1 to 3 byte-numbers individually or in combination yield addresses for three successive classes of networks categorized as class A, class B and class C (leaving alone the other two classes and the left end marker bits). Balance number(s) provide(s) the corresponding interface addresses for the above three classes respectively. Notwithstanding the many props devised, the total number of 4,294,967,296 available addresses were almost exhausted rather quickly to the consternation of the networking community.

As a result, the next generation IPv6 addressing system was developed in a replacement effort. Eight hexadecimal detached numbers each having decimal values ranging from 0 to 65535 are used with seven colons separating them. Combinations are made between them which provided a fairly large total number of addresses of 340, 282, 366, 920, 938, 463, 463, 374, 607, 431, 768, 211, 456.

Routing is the part played by delivery/transmission process. Traffic from one IP network into the next is initiated by the source host followed by IP routers lying enroute. Any router is concerned with its next hop and not the entire route and for this purpose, routers have to prepare and maintain routing tables. By referring to the entries in this elaborate table and mapping it with the network prefix address subsequent suitable routers/routes are chosen and packets are getting forwarded accordingly. The IP service begins for the dispatch of the next datagram.

The IP Suite's way of routing is improved upon by piggybacking on it the label switching routing (MPLS) thereby adding labels to IP packets. MPLS normally delivers high speed L2—“Label” switching at low working cost compared to the traditional routing, besides providing other advantages like QOS, VPN etc. This mode of routing enhances data integrity, recognizes a class of service (COS), allows for prioritization of traffic, and recovers quickly from link or node failure that changes the topology of the backbone by adapting to the new sets of constraints.

1.2.b. Drawbacks and Short Comings

The prior art network based communications and data transfers set up is suffering from many drawbacks and short comings. The seriousness of various problems besieging the computer communication industry has to be realized.

As regards addressing, as stated already, in the present art each computing systems interface as well as the network to which it is attached must be uniquely identified on global basis. Further, one and the same computing system will acquire two or more of such twin addresses if it is connected (multi homed) to as many networks. The network and interface addresses are similar to area and street addresses in postal delivery system, that is, the route guides to reach the destination. If two or even three streets from different localities connect a plot, a home therein will never attain two or more different addresses.

The address anomaly does not end there. Physical addresses such as MAC address are also needed in addition. This is also not meant for the computing device proper but to another component, namely, the Network Interface Card (NIC) or the adopter. Obviously, this will also be more than one relating to a device connected to multiple networks or sub networks. This confounds and compounds the method and system arrangement. More importantly, the whole process renders the resulting communications impermissible because it is the NIC as the final addressee that must retain the packet and should not pass it on to the unaddressed host computers. The delivery under the present art is, therefore, illegal as correct delivery to the exact address is mandatory and forms the essence of communication.

Further, both IPv4 and IPv6 addressing systems of IP service have their own problems and drawbacks. IPv4 addresses have been exhausted due to the limited number of addresses it possessed as against the phenomenal growth of LANs and the consequent demand for addresses. The next generation IPv6 possessed comparatively a large number of addresses and it is believed it will not get exhausted so very easily. But as it is also finite it will also get exhausted some day, sooner, if any unexpected huge network usage springs up in yet another device. Further the IPv6 system addresses are structured and so the number effectively available will be less according to the administrative policy adopted. Moreover, the first four hexadecimal numbers are only meant for the networks. So, only 18,445,618,199,572,250,625 networks can possibly be provided with addresses.

If an unexpected technology could provide still further cheap LANs then shortage of address under IPv6 will force the inter-netting community to evolve all kinds of fixes as had been attempted for IPv4. Ultimately, a new addressing mechanism replacing IPv6 will have to be searched for.

In addition, IPv6 could not and did not displace IPv4 as anticipated. Coexistence of both these systems causes immense problems too. IPv4 hosts and routers could not handle IPv6 traffic and vice-versa. The fundamental difference is IPv4 uses 32 bit and IPv6 uses 128 bit addresses. Besides, the header format and method of processing the header information are drastically different. Therefore, dual IP Layer stack Transmission Mechanism (DSTM) or 6 over 4 or 6 to 4 or ISA/TAP (Tunnel brokers) or address resolvers have to be provided to deal with both types of traffics. Either the total replacement of IPv4 with IPv6 technology or the other provisions like DSTM for working with both of them costs lot of money.

As regards routing, in telecommunication (circuit switching) networks, the country code (USA-001), city code (Worcester-508), area code (769), and the destination number (5920) are all provided by the ISD addressor. Similarly, in postal networks also, country (UK), city (London), area (Eastham), road (Masterman Rd) and home number (122) are all supplied by the addressor. Both these addressors are able to visualize to a large extent how his/her communication travels through. But in the internet communication alone the datagram packets or solicitations are thrown at the mercy of a router with just the destination name supplied mostly or the IP address number furnished occasionally. Though there is less botheration for the addressor in this type of communication it is with considerable cost only this is made possible. Routers are forced to dig out/search for their own routers/routes hop-by-hop to deliver those packets or requests. This lack of precision is costing money by way of routing tables, protocols, storage and control devices, CPU, memory, software etc required to enable this kind of intelligent routing functions, besides consuming lot of inter-netting time.

Though lot of expectation is placed on the MPLS-IP combination method of routing mechanism it is weighed down by high cost of investment involved. Further, the technology is suitable for large scale data network used by Enterprises, Carriers and ISPs only. Moreover, though the core does not see any IP address, still routers and addresses are visible in the PE routing table. Still further, it is used in “IP only” networks and in practice it is mainly used to forward IP datagrams and Ethernet traffic. Its major application revolves around Telecommunication Traffic Engineering and MPLS VPN only. More importantly, MPLS imposes restriction that ISPs could only provide services out of the locations that are interconnected on their backbones. In short, under the prior art, the most desirable explicit path method can't be extended to end user-to-end user communications

Under the prior art structure, in computer communications and data transfers costly network(s) are needed, inadequate addressing and defective delivery are used, highly involved routing is necessary and end user-to-end user explicit paths are not formed without prior route discovery and therefore major rectifications are called for.

### 2. SUMMARY OF THE INVENTION

### 2.1 Object of the Invention

It is the main object of this invention to evolve an alternate structure with improved technologies for not using any network as a medium or carrier for computer communications and data transfers.

It is also an object of this invention to adopt an inexhaustible single address system that will enable any number of hosts themselves to possess a globally unique permanent address—instead of their interfaces and the networks to which they are linked or the NIC through which they are so connected to interfaces and networks as in the prior art—which should require no further replacement.

It is another object of this invention to make this addressing system adopted herein to replace the existing systems with the aim of removing the improper delivery by being legal in its delivery function totally and by being an efficient alternative.

It is yet another object to establish end-to-end explicit dedicated route specification between source and destinations station without any advance route discovery by creating hierarchical exchanges meant for switching and transferring data.

It is still another object of this invention to obviate the need for intelligent routing through routing or switching tables along with the related elaborate processing activities that are being performed by a router or routing switch in setting up a delivery path using hop-by-hop look up technology or a priori route discovery procedure for dedicated connection through call set-up including label switching.

It is a further object to modify the frame format with suitable artifice to suit the simplified addressing, forwarding and routing/switching technology evolved herein coupled with secured communication.

It is a still further object to make the modified frame called Data Route Compact to flow through 32 or 64 or 128 bit routing switches.

Description of this invention which follows will depict additional objects and advantages which will be obvious in part from this description or may be learned by practicing this invention. The objects and advantages of this invention may be realized and derived from technologies, systems and methods particularly pointed out in the appended claims.

### 2.2 Statement of the Invention

In order to achieve the foregoing objects and in accordance with this invention as embodied and broadly described herein a new structure meant for electronic communications and data transfers emanating from and through computers has been evolved without involving or using costly network as a medium/carrier but by including specialised arrangement/setups relating to location of computer and LAN end users and improved processes and mechanisms regarding addressing, end user-to-end user recorded paths, routing/switching and frame format technologies.

The method of yielding infinite address numbers by using Base 256 (Hexa QuarterK—HQK) numbering system is adopted in this invention. (The alternate technique of adopting Base 65536 (=256²−HexaQuarterKSquare—HQKS numbers is also indicated in case large magnitude address numbers are to be avoided).

This invention is, therefore, directed to affix a globally unique permanent address number on each computing device alone without the need for and use of any other extraneous address

The above embodiment of this invention, in addition, removes the requirement for any physical address (such as MAC address) which is being stamped to the NIC under the prior art. More importantly the illegal delivery of packets to an unaddressed device is totally prevented/banished. The consequence of the above embodiments is the facilitation of complete change over from the existing (IPv4 or IPv6) system to the HQK addressing system. This replacement will be long lasting without requiring any further transformation.

Another embodiment prescribes methods and specifications for an orderly Global communication Topology (GCT) and a hierarchical architecture of all access provider exchanges whereby end user-to-end user route locus delineation and dedicated peer to-peer communication is made possible and assured. This embodiment enables to configure explicit Strict Prescribed Path (SPP) at the threshold stage itself in advance (without the need for any prior route exploring expedition) and this countrywide recorded route is fixed once for all for every end user with the use of an electronic Global Strict Prescribed Path Address Directory (GSPPAD).

Yet another embodiment stipulates the routing switches to read only Route Indicators (RINDS) along the SPP and forward the artifice developed in this invention (described in a subsequent embodiment) containing the data towards its next exchange commencing from one end user and reaching the other end user. Thus forwarding is from hop-to-hop but along a predetermined prescribed path.

In accordance with all the above embodiments the workload of the routing switches is reduced enormously as they have to just read a maximum of three digit decimal number between 0 to 255 (a single digit HQK number),—an eight bit binary number of the successive access provider exchanges—to forward data received by the routing switches to a hierarchical group or set-up of access provider exchanges without any look up of routing tables or switching tables.

The modified frame called Data Route Compact (DRC) will be incorporated with all access providers' route Indicators (RINDs) along the Strict Prescribed Path (SPP)-eliminating repeated reference to source and destination addresses.

The DRC will be suitably compressed or elongated as invented in this invention to make it flow through varying routers/switches using 32 or 64 or 128 bits.

These and other embodiments, aspects, and features of this invention will become more fully apparent from the following description, drawings and appended claims.

### 2.3 Effect of the Invention

This invention has brought about drastic changes in the network communication. The alternate structure now evolved totally eliminates the concept of networking and internetworking, that is, the communication through the network of networks linked together. In other words, networks are no more needed as carriers in the communication envisaged in this invention.

In the scheme worked out and explained hereinafter, computers will only remain as end user hosts hooked up to an access provider exchange in one or the other fixed permanent recorded communicating path either to receive or send data messages. However, the end user can be a LAN having a single border/end point gateway. But such networks are not used as carriers for communications with other end users except within itself, that of course is an exception retained from the legacy communication structure.

Apart from the above far reaching effect, the invention has also brought about important and significant changes and improvements in the addressing system and method, routing/switching technique, and frame formatting process.

It is to be understood that both the general description and the following detailed description are not restrictions of the invention as evolved. By the use of the language the readability and instructional purposes of the invention is only meant but not the delineation and circumscription of the inventive subject matter.

### 3. BRIEF DESCRIPTION OF THE DRAWINGS

The description portrays the novel features—the investigative outcome—of this invention. The invention along with its uses, objects, features and advantages, already recited furnishing a more particular description by reference to specific embodiments thereof, will be explained further with the assistance of and by referring to the drawings. These drawings display typical embodiments of the invention and should not be construed as limiting its scope in any manner. Additional specificity and details of the invention will be described and put forth in the following description of the preferred embodiments with the use of the accompanying drawings, in which:

FIGS. 1 (a), (b), and (c) display the division of a country into primary Segments (PSs) (for example Australia), Secondary Segments (SSs) (for example inside PS-88 abcd), and Tertiary Segments (TSs)(for example inside SS 103-klmn).

FIGS. 2 (a), (b), and (c) portray the Access Provider Exchanges such as LE, HOSTs with or without GRs inside a TS (for example inside TS 120-pqrs).

FIG. 3 depicts the hierarchical Global communication Topology (GCT) with different categories of access provider exchanges (900 to 550) in specific order indicating flow also.

FIGS. 4 (a), (b) and (c) describe the Strict Prescribed Path (SPP) with Route Indicators (RINDs) and direction of flow (without any a priori route exploring expedition for a dedicated connection) under differing communication situations.

FIG. 5 shows the Data Route Compact (DRC) which will be forwarded from source to destination through a series of access provider exchange routing switches. It carries the data in encrypted condition.

FIG. 6 describes the mechanism of ‘instant fading—flash highlighting of RINDs’ at every access provider exchange routing switches and the data flow.

### 4. DESCRIPTION OF THE PREFERRED EMBODIMENT

Detailed description of the preferred embodiments of this invention will be given herein after with reference to the drawings.

### 4.1 Addressing System

4.1.a. Device attached inexhaustible permanent addressing system

Evolving addressing systems one after the other periodically in succession is not a desirable feature. A permanent addressing system must only be in place to spare the hapless several million users from forcing them to make investments after investments. Such an address system is evolved in this invention, which will be inexhaustible and must be permanently stamped on each computing device alone.

4.1.b. Reasons for adopting base 256 (HexaQuarterK—HQK) number system

Any numbering system will count upto infinity, rather, its numeration will not see the end; however, it must eminently be suitable for computing to achieve any purpose of an invention in the field of communications and data transfers.

A number is represented by a single to series of countless digits (with one or multiple numerals in each digit)—the numbering system having all digits in single numeral being more popular and readily preferred. Each digit therein assumes a value based on the position it occupies in the string counting towards left with zero at the right end. The value of a number in any base system is given as follows:

V=Cₙbⁿ+Cₙ₋₁bⁿ⁻¹+Cₙ₋₂bⁿ⁻²+ . . . ++C₂b²+C₁b¹+C₀b⁰, where

v=Value of a given digit string/series of a number
b=base and, c=any digit occupying some particular position in that string

The values of digit string 1101 assumes different decimal values in various numbering systems are as under:
i) Binary (base2) system—1101=1*2³+1*2²+0*2¹+1*2⁰=8+4+0+1=13
ii) Octal (base8) system—1101=1*8³+8²+0*8¹+1*8⁰=256+64+0+=577
iii) Decimal (base10) system—1101=1*10³+1*10²+0*10¹+1*10⁰=1000+100+0+1=1101
iv) Hexadecimal (base16) system—1101=1*16³+1*16²+0*16¹+1*16⁰=4096+256+0+1=4353
v) HQK (base256) system—1101=1*2³+1*256²+0*256¹+1*256⁰=16777216+65536+0+1=16842753

The maximum decimal values that can be attained for the four digit string under the above five systems are shown below:
i) 1111₂=15₁₀
ii) 7777₈=4095₁₀
iii) 9999₁₀=9999₁₀
iv) FFFF₁₆=65535₁₀
v) (255), (255), (255), (255)₂₅₆=4294967295₁₀

Since the resulting decimal value is enormous in the HQK system, this is the first reason for choosing it. In other words, by assigning the HQK numbers 0001 to 255,255,255,255 about 11.4 billion end user devices and local area networks will be getting globally unique addresses

The number of numerals involved in the numeration in any system depends on its base or radix as follows:
i) Binary—0 and 1 (Total 2)—eg. 101010 (Binary number)
ii) Octal—0 to 7 (Total 8)—eg 7060543210 (octal number)
iii) Decimal—0 to 9 (Total 10)—eg 9876543210 (Decimal number)
iv) Hexadecimal—0 to 15 (Total 16)—eg. (15)0 (14)0 (13) (12)(11) (10) 9876543210 (Hexadecimal number)
v) HQK—0 to 255 (Total 256)—eg. (255)0 (254)0 (201)(169) (121)(89) (13) (12) (11)(10)9876543210 (HQK number)

The second reason for choosing HQK number is that the value any one of its digits can assume is only 0 to 255 and all of them could be depicted by an eight digit binary octet or byte, that is, 00000000 to 11111111 as needed for computing purposes.

It is possible to write each digit of any number of the first four systems in a single numeral, that is, a number can be formed by contiguous digits in a string with single numeral for each digit except in the case of hexadecimal numbers with numerals of 10 to 15 which are shown above written in brackets. This difficulty is got over by substituting alphabets A to F for those six numerals and the hexadecimal number above becomes F0E0DCBA 9876543210 with single alpha numeral digits. Since such a trick is not easily possible in the case of HQK numbers, any double or triple numeral digit has to be shown as such with suitable separating identifiers: There are four possible forms for representing HQK numbers as text strings:

i) (234) (86) (119) (7) (45) (2) (10) (0) or
ii) 2̅3̅4̅ 8̅6̅ 1̅1̅9̅ 7̅ 4̅5̅ 2̅ 1̅0̅ 0̅ or
iii) 234˜86˜119˜7˜45˜2˜10˜0 or
iv) 234, 86, 119, 7, 45, 2, 10, 0

We are familiar with the fourth format and the same is adopted herein.

4.1. c. Advantages of the Proposed Address System

The Base 256 (HexaQuarterK—HQK) system numbers more fully described above is adopted in this invention to provide the one and only address to the communicating devices alone in the entire communication system. These numbers are inherently inexhaustible by any means and will never be in short supply. In this invention, innumerable, in fact, endless digits of values each from 0 to 255 are used in strings/series with the stipulated understanding of the general numbering theory that each digit of that HQK number (having one to three numerals) has to be first multiplied by 256 to the power of ‘n’ which power n being the same as its position in that contiguous series counting right end digit as zero and increasing towards left and adding the sums of all such multiplications. For example, a sixteen digit (128 bit) HQK number 255, 255, 255, 255, 255, 255, 255, 255, 255, 255, 255, 255, 255, 255, 255, 255 gives a decimal value of 255×256¹⁵+255×256¹⁴+ . . . 255×256⁷+ . . . 255×256¹+255×256⁰. This itself provides a value of 2.8×10³⁸ which compares well with 3.4×10³⁸, the maximum possible value under the IPv6 system. However, the former value under this invention is not finite as the latter one of IPv6 system and is only a fractional part. In fact, the total digit constituting the text strings of HQK number could go on to any extent. Moreover, each digit could be represented by an eight bit binary number for computing purposes as every one of its value varies from 0 to 255 only.

This permits each address (HQK number) to be permanently and uniquely assigned to a computing device proper in whichever location it is or is going to be. Obviously, as the node itself is getting stamped with an address number there is no need as in the prior art for any extraneous identifiers The addresses under this invention serves to trace the SPP route only and not for any other purpose including routing.

4.1. d. Compression of the Address Numbers

The Hexa QuarterK numbers will be reduced to a concise form by replacing the set of zeros in them through symbol representation, that is, groups of zeros may be replaced by symbols or signs shown below:

1 zero—0 (zero)
2 zeros—; (semi colon)
3 zeros—: (colon)
4 zeros—. (dot)
5 zeros—.. (double dot)
6 zeros—' (apostrophe)
7 zeros—\hat{ } (wedge)
8 zeros—✓ (Tick)
9 zeros—! (Exclamation)
10 zeros—* (star)
11 zeros—*, 0
12 zeros—* ;
13 zeros—*, :
14 zeros—*, .
15 zeros—*, ..
16 zeros—*, '
17 zeros—*, \hat{ }
18 zeros—*, ✓
19 zeros—*, !
20 zeros—*, *
21 zeros—*, *, 0
22 zeros—*, *, ;
23 zeros—*, *, :
24 zeros—*, *, .
- - -
26 zeros—*, *, '
- - -
28 zeros—*, *, ✓
- - -
30 zeros—*, *, *
- - -
35 zeros—*, *, *, ..
- - -
37 zeros—*, *, *, \hat{ }
- - -
40 zeros—*, *, *, *
- - -
60 zeros—*, *, *, *, *, *
- - -
80 zeros—*, *, *, *, *, *, *, *
- - -
100 zeros—*, *, *, *, *, *, *, *, *, *
- - -
And so on

It is evident the HQK number addresses will contain long strings of Zeros. In order to shorten the length of these numbers, those zeros will be suitably substituted with signs, that is, groups of zeros could be replaced by representative signs as shown above.

### Eg: 183,0,61,0,0,0,0,0,0,0,0,0,0,32=183,0,61,*,32

183,0,61,0,0,0,0,0,0,0,0,0,0,0,0,0,0,0,0,0,32=183,0,61,*,̂,32

4.1. e. Conserving the Numbers

These addresses will be needed for A) Stand alone computers B) Thin Clients), C) Embedded Systems and D) Automobiles Systems. So if an address is identified regarding its class or Category to which it belongs to by making the digit string followed by a slash (“/”) and category alphabet at the end, then one and the same number could be assigned to all the four different categories of devices as shown below:

### 183,0,61,*,32/A—Standalone-computers

### 183,0,61,*,32/B—Thin-Clients

### 183,0,61,*,32/C—Embedded-Systems

### 183,0,61,*,32/D—Automobile Systems

By this repetitive use of the HQK numbers it will be possible to keep it at lower magnitudes thereby limiting the need for large/long HQK numbers.

In addition, it will also be possible to sub-divide each category as A1, A2, A3, A4 and A5 depending on whether the stand alone computer is in 1 continent or in any of the other four continents. In such an event, the same number could be attached/assigned to stand alone computers in 1 to 5 continents which will naturally conserve the numbers and keep them at lower order. Thus

183,0,61,*,32/A1—stand alone computing devices in continent 1
183,0,61,*,32/A2—stand alone computing devices in continent 2
And so on for the other 3 continents 3 to 5; so also for B to D devices.

Alternatively, Base 65536 (HexaQuarterK Square—HQKS=256²) number system could also be adopted instead, if keeping the address numbers at low magnitudes is a major and critical constraint for any reason.

The maximum decimal value of 128 bits (8 bytes of 16 bits each) HQKS number, Viz, 65535, 65535, 65535, 65535, 65535, 65535, 65535, 65535 will be 65535×65536⁷+65535×65536⁶+ . . . +65535×65536¹+65535×65536⁰=2.2×10⁴⁵. This is quite a formidable number of addresses. Besides, evidently this is not the end. The digits could go on endlessly as explained for the HQK number addressing system. In this system, the individual digits will vary from 0 to 65535 which could be represented by a hexadecimal format. The computer usable format for the above 128 bit number is FFFF, FFFF, FFFF, FFFF, FFFF, FFFF, FFFF, and FFFF. This may not be needed, since the addresses are not involved in the routing/switching process and hence number of bits handled is irrelevant.

### 4.2. Global Communication Topology (GCT)

The Internet being a loose structure portrays a topology which is in the prior art based mainly on the perceived commercial needs that are satisfied by Network Service Operators. Some of them concentrate on providing ‘core’ networks, some on connecting private users and still others providing transit between users and the core. Though there is some degree of hierarchy in operation there is no order in the topology of these networks. The haphazard layout of networks of these service providers as well as the end users prevailing in the prior art prevent a well defined delineation or demarcation of explicit data flow routes or recorded routes in advance compared to telecommunication or postal networks.

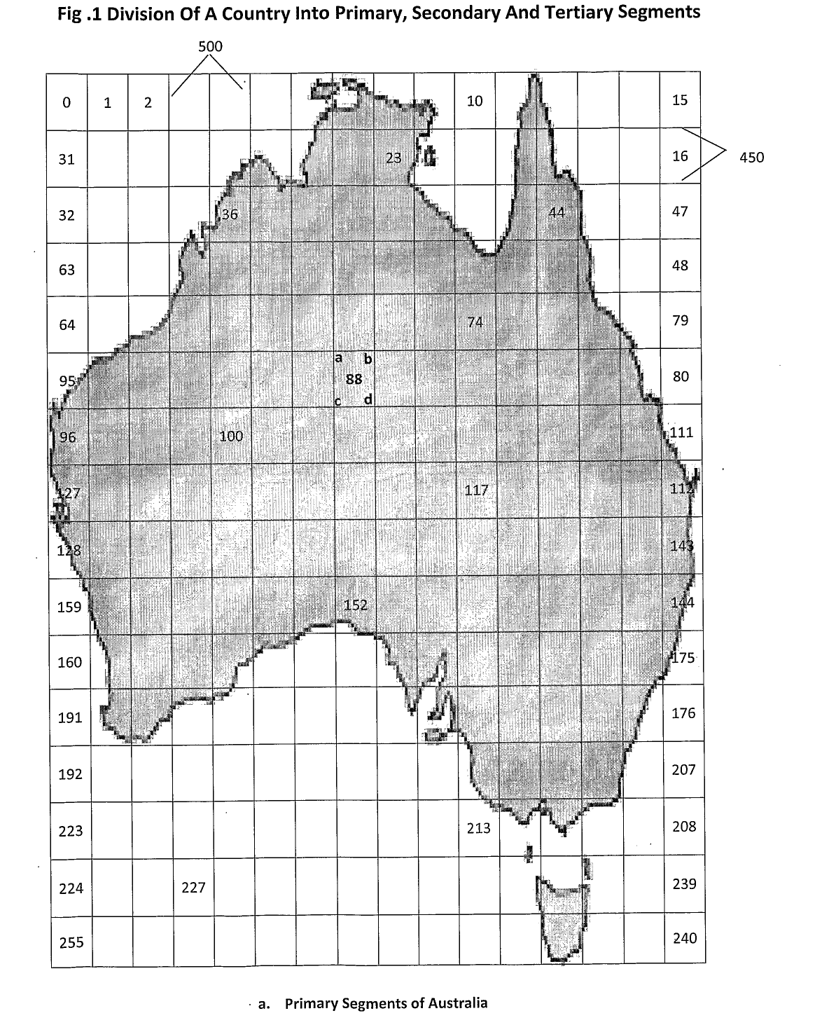

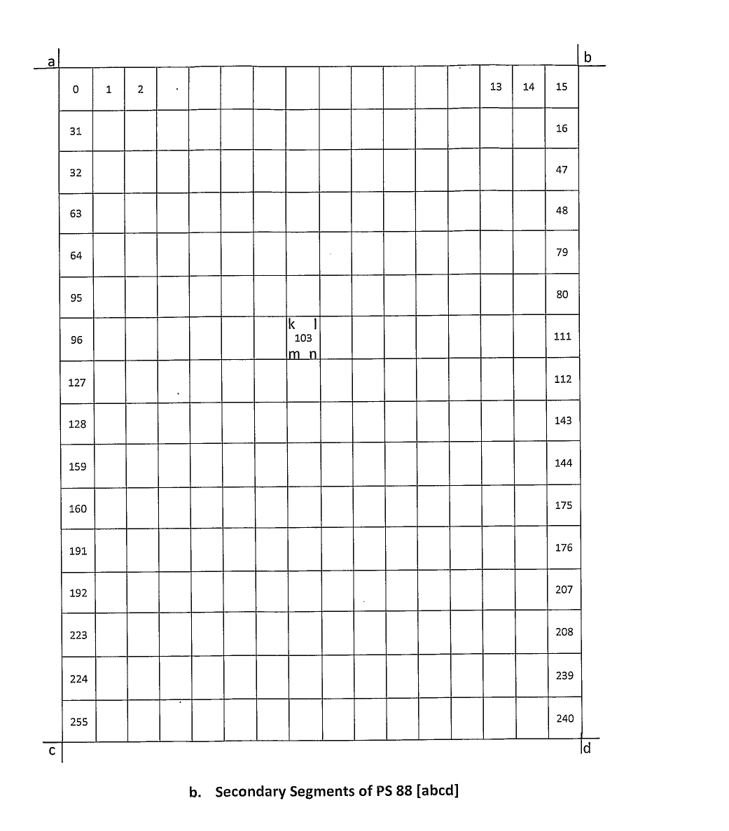

Therefore, this embodiment of the present investigation evolves the Global Communication Topology (GCT) portrayed in FIGS. 1 to 3. In this scheme, every country in a continent is divided under the HQK system into 256 grids (or 65536 grids under the HQKS system) called Primary Segments (PSs), using seventeen longitudinal divisors and latitudinal divisors each as in FIG. 1(a). These grids are numbered from o at the top left corner and left to right and right to left alternatively in successive descending rows. Each PS is further divided into 256 Secondary Segments (SSs) likewise and numbered in the same fashion as shown in FIG. 1(b) (shown for one PS-88). In the same manner every SS of all the PSs are partitioned similarly into 256 Tertiary Segments (TSs) and numbered in a like manner as depicted in FIG. 1(c) (shown for one SS-103).

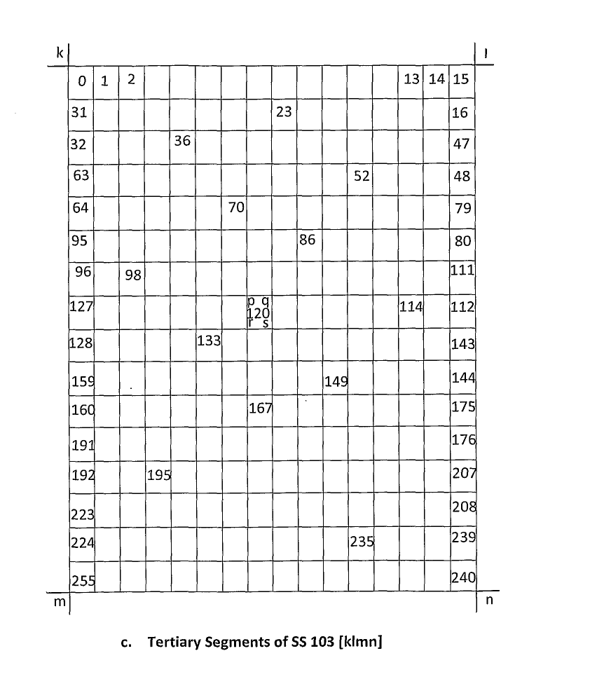

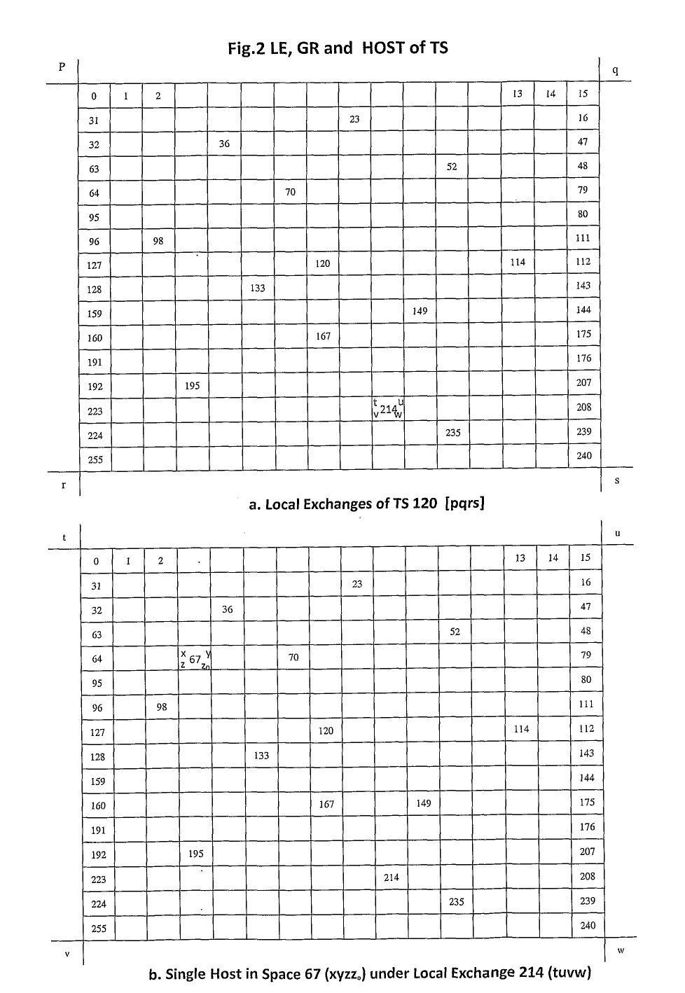

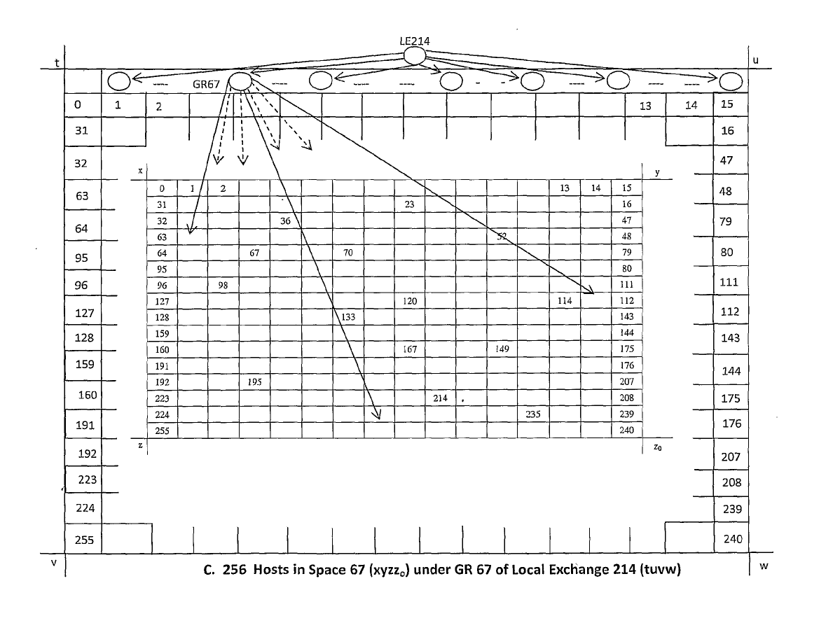

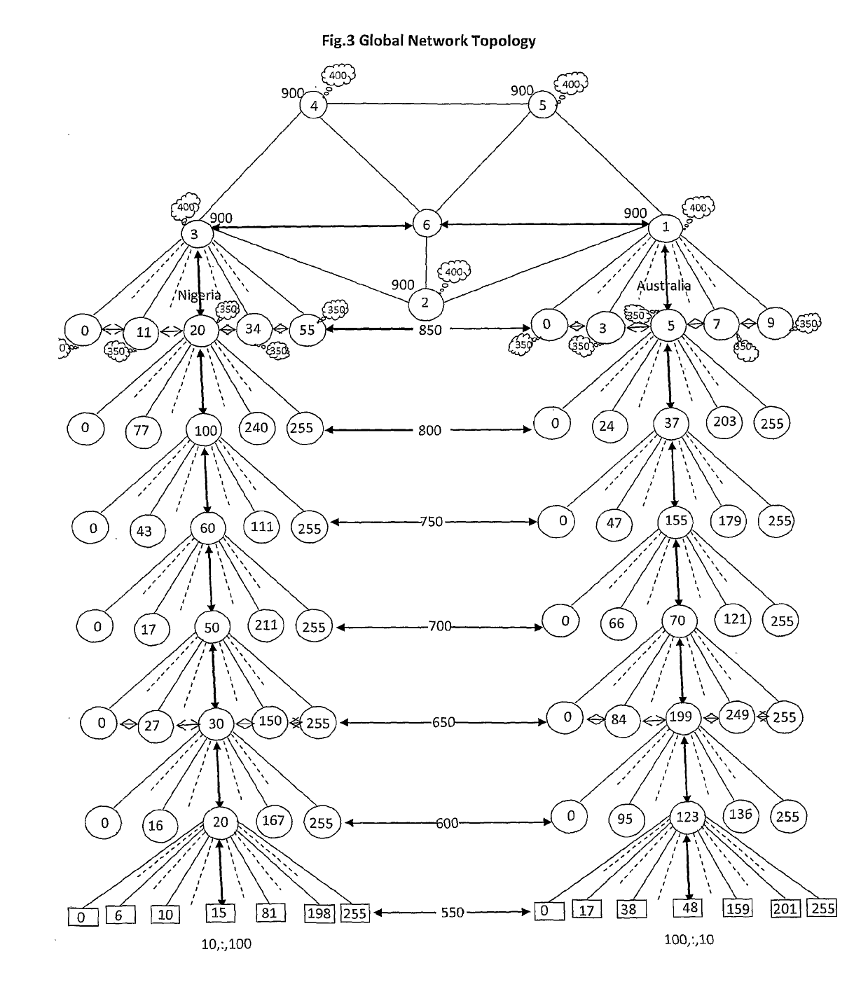

A National Exchange (NE) connects to all 256 Primary Segment Exchanges (PSEs) by having one PSE in every PS. Each PSE connects to all the 256 Secondary Segment Exchanges (SSEs) under it, with one SSE per SS. Each SSE is linked to all the 256 Tertiary Segments Exchanges (TSEs) located in all the TSs of that SS (at the rate of one each in every TS). To each of these TSEs, 256 Local Exchanges (LEs) are connected (FIG. 2a). Normally, each LE will be able to connect to 256 hosts or end users only (FIG. 2b). To get over this difficulty logical routing exchanges are devised if required. Thus each LE connects to 256 Group Routers (GRs) and each of those GRs in turn connects to 256 hosts (FIG. 2(c)). Alternatively as stated each LE connects with 256 end users directly. Thus each LE contains or caters to either 256 or 256*256 hosts. This hierarchical routing arrangement is shown in FIG. 3.

In a 10,000 by 10000 kilometres extent country there will be one TSE in every 6 sq. kilometer land area. Actually the areal extent of each Tertiary Segment in the largest country Russia will be 1 sq.km, in Australia 0.5 sq.km, in Mexico 0.125 sq.km and in France less than 0.04 sq.km. Even in Russia, there will be a LE for every 4000 sq.m (63 m×63 m) area and one PC or LAN in every 16 sq.m (4 m×4 m) area without any GR being used. Thus the requirement for GR mostly may not arise and will be needed only if the density of end user devices grows excessively. Therefore, smaller countries may be probably divided into 10 by 10 or still less size PSs, SSs, and TSs, grids without using GRs.

National Exchanges in all the countries in the five continents (NEs) are hooked up with their respective Continental Exchanges (CEs). There could be up to 256 NEs in each CE but actually at the maximum about 50 or 60 CEs (or much less) may be there (there being about 233 countries in all the five continents). The CEs and NEs are backed up by Core and Backbone Networks and, therefore, both CEs and NEs will possess large scale equipment racks, power supplies, cable trays, gigabit switches functioning as big Internet data centres taking care of security, disaster protection, high band width connections etc. The various exchange nodes, route indicators and the reference numbers stated above and shown in different figures are detailed below:

### Route Indicators (RINDS) and Reference Numbers.

950—DRC—Data Route Compact
900—CE—Continental Exchange (Access Provider)—Total 6 Nos (1—Australia; 2—Asia; 3—Africa; 4—Europe; 5—America; 6—Mesh)
850—NE—National Exchange (Access Provider)—Total 256 Nos (but may be about <50 for each CE)
800—PSE—Primary Segment Exchange (Access Provider)—Total 256 Nos (Fixed for each NE)
750—SSE—Secondary Segment Exchange (Access Provider)—Total 256 Nos (Fixed for each PSE)
700—TSE—Tertiary Segment Exchange (Access Provider)—Total 256 Nos (Fixed for each SSE)
650—LE—Local Exchange (Access Provider)—Total 256 Nos (Fixed for each TSE)
600—GR—Group Router (Access Provider)—Total 256 Nos (Fixed for each LE)
550—Host—Total 256 Nos (Fixed for each GR or the LE as the case may be)
500—Longitudinal devisors
450—Latitudinal devisors
400—Continental Backbone Networks
350—National Backbone Networks
300—Direction of Transmission of Bits

### 4.3. Strict Prescribed Paths (SPPs)

As per this invention, HQK numbers are assigned to all the hosts in all the five continents which become their globally unique permanent addresses. All such addresses along with the location of every host (starting from CE to HOST) will be compiled in an electronic directory called Global Strict Prescribed Path Address Directory (GSPPAD). These particulars would have been forwarded to GSPPAD by each end user computer or LAN immediately on its installation in a particular grid location in a country. For instance, the computer 10,:,100 may be in Nigeria in Africa continent (No3). The GSPPAD will furnish on demand, for example, the following information: Host 15, GR 20, LE30, TSE 50, SSE 60, PSE 100, NE 20, and CE 3 for this 10,:,100 source computer, the 15^{th} end user. Such particulars, called Route Indicators (RINDs), will be available against each host's address in the GSPPAD.

If the above computer wants to correspond with another computer 100,:,10 in Australia, continent 1, the GSPPAD will immediately return the following RIND for this destination end user: Host 48, GR 123, LE199, TSE 70, SSE 155, PSE 37, NE 5 and CE1 on request from the computer 10,:,100.

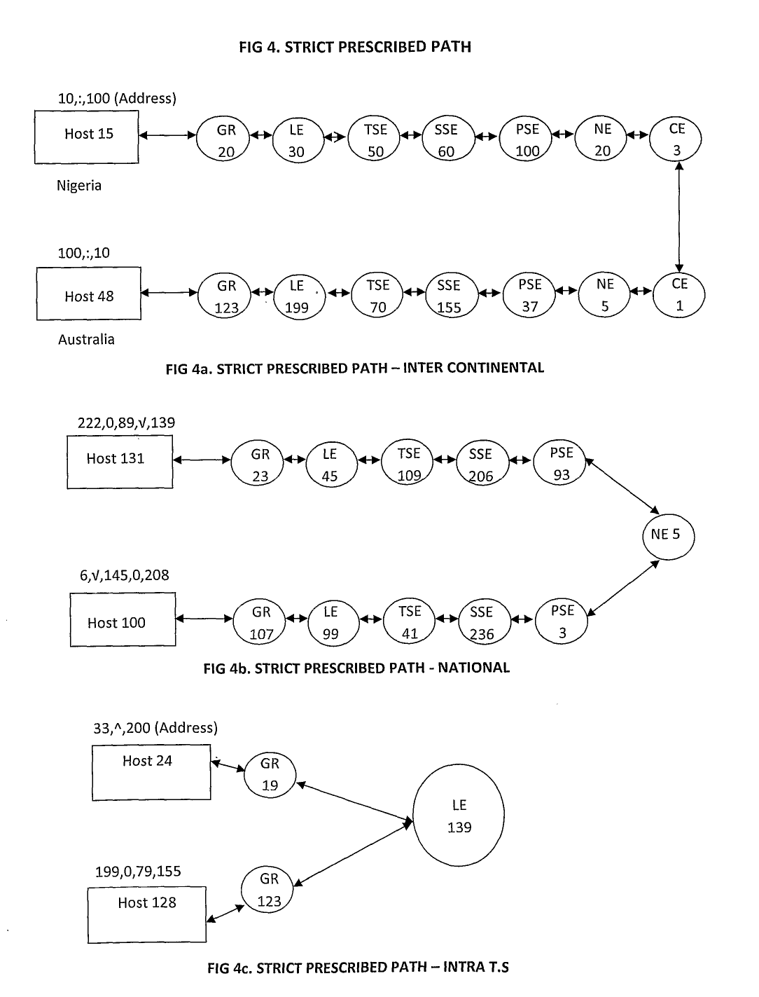

With the above two sets of RINDs, the locus of global SPP between the two Computers 10,:,100 and 100,:,10 lying in two continents could be fixed and drawn as shown in FIGS. 3 and 4 (a). The data flows in both directions are also indicated therein.

SPPs between two computers situated within a country and within a GR or LE are shown in FIG. 4(b) and (c) respectively. There are still other types of communications between different other sets of hosts than that indicated in FIG. 4.

### 4.4. Data Route Compact (DRC)

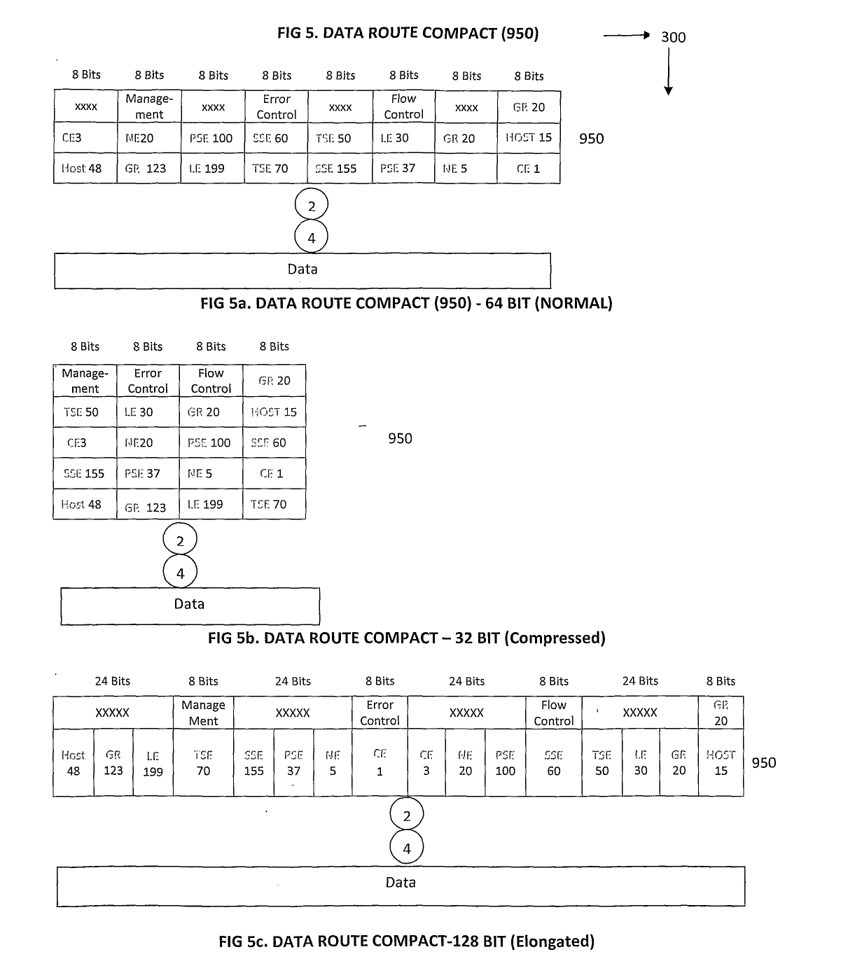

Instead of frames or cells which are routed/switched and forwarded to move data from source to destination in the traditional prior art system the artifice evolved for this purpose in this invention is a Data Route Compact (DRC-950) comprising of two boxes attached together (FIG. 5). The bit length of the compact could be arrived at 64 based on the eight RINDs of eight bit each commencing from HOST to CE. In the upper box the RIND values are of source and destination placed one each in separate compartments of its second and third rows. The second row compartments contain the RIND figures pertaining to the flow from the source host to CE and the compartments in the third row store the RIND data relating to the flow from CE to the destination host. The routing and forwarding takes place in accordance with these RIND figures contained in the middle and bottom row compartments of top box sequentially read from right to left. The compact thus moves forward from source to destination, traversing through the various forwarding exchanges designated and identified by all these RINDs. Successive RIND numbers will get highlighted in the right most compartment of the first row of top box. The next three alternate compartments of this row are used for flow control, error control, and management functions. The other alternate four compartments commencing from the second one from the right end will be padded with non-zero characters. The number highlighted in this top row right end compartment will fade instantly as the DRC touches the exchange indicated by it. The next number of the immediate subsequent exchange gets highlighted in that compartment in a flash. This process is referred to as ‘instant fading-flash highlighting of RINDs’

The link connecting the top and bottom boxes is having two rings attached securely one over the other. These two rings are used to indicate the order of data sent in that particular compact, for instance, the numbers 2 and 4 in the top and bottom rings reveal that this particular data is the 2^{nd} part out of the total 4 parts of the data sent. This detail facilitates reassembly of data later in the destination user.

The bottom box is used to place a maximum data of 65535 bytes (less the bytes needed for the top box and middle connecting coupler image). This data is then encrypted by the source computer using the technology developed in this invention and the camouflage used for this purpose is created by a secret code developed in this invention. The same camouflage will be available with the destination user also and with its help the data will be decrypted and used.

The direction of transmission of bits from the DRC on to the media line commences from right end towards left in the first row of the top box and proceeds downwards to the end of the bottom box. The three rows of the top box will be transmitted in bits, the central connection coupler will be transmitted in pixels and the bottom box data in bits in that order.

### 4.5. Routing Switches

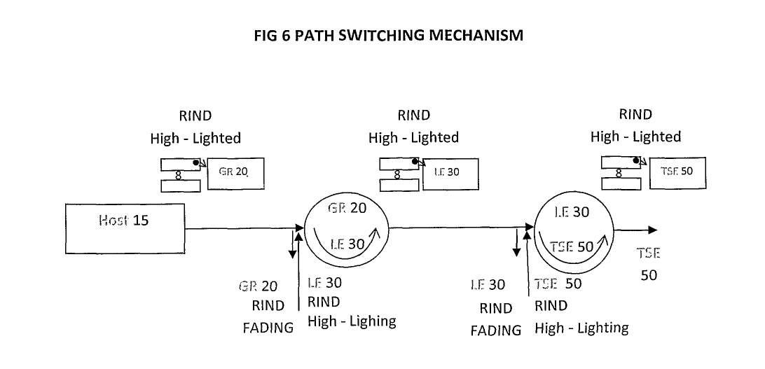

The routing/switching method (FIG. 6) in this invention is using DRC in circuit switching transfer mode. The source host (Host 15) high lights its immediate neighbour RIND namely that of the GR (GR 20) and forwards the DRC in that link. As the DRC nears GR 20, that GR compares its own RIND with that of the high-lighted RIND. Based on this mapping it accepts the compact. At that very instant, the OR-RIND (GR 20) fades away and the next immediate neighbour LE's RIND (LE 30) gets high-lighted in a flash (FIG. 6). The inward line card of the GR 20 receives the DRC from the incoming interface, forwards it to the switching fabric of the routing switch with this latest high-lighted (LE 30) RIND. The switching fabric hands the DRC over to the outgoing line card which forwards the DRC with the high-lighted LE 30-RIND to the appropriate outgoing interface. DRC moves to the LE 30 where this process gets repeated and the compact gets forwarded to the TSE with that exchange's RIND high-lighted. Where the GR-RIND Compartment is padded (in the absence of GR), the RIND from the next compartment gets highlighted. The DRC moves to the LE directly in the absence of the GR without any difficulty. This method of switching, forwarding and transmission functions goes on till the destination host is reached. On mapping the high-lighted RIND (HOST 48) with its own, it receives the DRC and the communication comes to an end. The destination computer decrypts the data using the camouflage developed in this invention and avails the data. Merely the number of each exchange is only getting highlighted (without the particular exchange's identity like LE, GR etc being included)

The forwarding function of this switching technique is simple besides being high performance forwarding and could be implemented in any high performance forwarding hardware available readily in the market to-day. The fundamental requirement is it should have 256 ports in one direction and should be capable of switching 64 bit DRCs and other routing switches must be programmed to compress or elongate the DRCs into 32 bit and 128 bit long ones.

Considering wide adoptability of the switching process, it has been developed in this invention the following technique: If the DRC meets a 32 bit routing switch, that switch compresses the DRC to 32 bit one from its 64 bit position as shown in FIG. 5(b) and if it encounters an 128 bit routing switch it gets elongated to 128 bit length as shown in FIG. 5 (c) to suit those routing switches. The four padded bits in the first row of the top box enables this process to be achieved admirably. The compression process removes the four padded compartments in the top row and splits the 8 compartments in the middle row into two four each ones and places the left side four compartments below the right side four compartments and in the same manner the bottom row compartments also are bifurcated into 4^{th} and 5^{th} rows with four compartments in each. In the elongation process the top row is increased to 128 bits by stretching each padded compartment into 24 bit ones. There is only one another row (second row) which will be having 16 compartments of 8 bits each depicting the complete route from source to destination.

All the National Exchanges of all the countries of a continent are inter-connected. Similarly all the LEs of a country are inter-connected. This arrangement provides alternate route in case of failure of any link or node.

Without departing from the spirit or scope or nature of the present invention put forth and claimed herein and described by way of embodiments there of and also as defined in the drawings, it may be possible for those skilled in the art to arrive at modifications, variations and changes in form and details and therefore all such variations, deviations and modifications falling within the nature, scope or spirit of this invention will be deemed to be covered by it.

These appended claims include equivalent arrangement covered within the spirit, nature, meaning, range, essential characteristics, and scope of the invention

I claim:

1) A new structure with specialized arrangements/set-ups/processes/mechanisms for improving the computer communicating and data transferring technologies, systems, and methods thereby eliminating the requirement of costly networks as carriers of communications (in, through, or over these networks).

2) The new structure evolved in claim 1 including a new system for improving the techniques and principles of addressing involved in the electronic digital communications and data transfers through computers comprising of base 256 (HexaQuarterK—HQK) numbering system yielding infinite address numbers (or 65536-HexaQuarterKSquare—HQKS numbering system, if so desired under compelling conditions, if any), stamping permanently these globally unique HQK (or HQKS) inexhaustible address numbers on every communicating computing device, (and facilitating effective switch over from the existing IPv4 or IPv6 address systems to the new HQK (or HQKS) system in a long lasting manner without requiring any further substitution whereby enormously favouring the billions of computer users by enabling them keep and use their hardwares without much further change after they come under HQK (or HQKS) addressing system) and further comprising, more importantly, the addressing system causing to deliver all communications in a legally valid manner to the addressee proper.

3) The new structure in claim 1 including in addition a Global Communication topology (GCT) arrangement in which every country being divided in HQK system into 256 (or 65536 in HQKS system) Primary Segments (PSs), 256 Secondary Segments (SSs) within every PS and 256 Tertiary Segments (TSs) within each of these SSs, having Access Provider Exchanges (APEs) established in all these three kinds of segments at the rate of one each in every segment wherein each Primary Segment Exchange (PSE) being connected to 256 Secondary Segment Exchanges (SSEs) of all SSs formed under that PS and in turn each SSE being connected to 256 Tertiary Segment Exchanges (TSEs) created under the respective SS and further connecting all PSEs to that country's National Exchange (NE) and all countries' NEs within a continent being connected to the Continental Exchange (CE) of that continent and still more, connecting all TSEs to 256 Local Exchanges (LEs), each LE being connected to either 256 end user computers (HOSTs) directly or 256 Group Routers (GRs) and then each GR being connected to 256 end user computers or LANs (HOSTs) if required and further each and every one of the said exchanges being designated and identified with its respective serial number of connection from 0 to 255 called Route Indicators (RINDs) wherein the continental and national exchanges having been endowed with huge capacity core or backbone network supports.

4) Structure in claim 1 including a new method for improving the techniques and principles relating to the technology of transfers of data involved in electronic digital communications through computers in combination and conjunction with claims 2 and 3 comprising of an electronic Global Strict Prescribed Path Address Directory (GSPPAD) developed specially to compile, and store the particulars furnished by every end user computers soon after their installation and for furnishing back, on request, these RIND particulars of all exchanges from CE to HOST as and when a request reaching it and there after the SPP being readily identified, established, and noted down in the new frame format developed in this invention called Data Route Compact (DRC) immediately on receipt of those particulars by the indenting host from the GSPPAD.

5) The new structure in claim 1 including the system and arrangement in claims 3 and 4 further comprising an artifice evolved for carrying the RINDs and data and transmitting them from one exchange to its immediate next neighbour in two separate boxes coupled together as a Data Route Compact (DRC) in which the RINDs being stored in the top box and the data in the bottom box, the top box having been divided into three rows and all the three rows having been further divided into eight compartments of 8 bit each, with four padded and four used up in the top row, all 8 compartments in the middle and bottom rows being fully used up (except GR compartments when not needed) wherein the right end compartment of the top row portraying the highlighted RIND to which the DRC ought to be forwarded, the other three alternate compartments from it being utilized for flow control, error control and management functions and filling the balance four alternate compartments commencing from second right end one with non-zero padding characters and the middle row 8 compartments containing the RINDs of outgoing flow emanating from the source host and reaching the CE read from right to left sequentially and getting highlighted in the right end compartment of the top row sequentially one after the other, while the bottom row 8 compartments containing the RINDs of incoming flow from CE to HOST read from right to left and getting highlighted similarly after the middle row RINDs highlighted and still further the bottom box containing the data being encrypted and decrypted using the technology and the camouflage developed in a secret process of this invention at source and destination computer end users respectively and further using the connecting coupler to carry information of fragmental parts out of the entire data being carried and required for reassembly later at the destination end user and still further the direction of transmission of bits from top and bottom boxes of the DRC commencing from right end and top to bottom respectively and further the top and bottom boxes being forwarded in bits while the middle connector coupling image being forwarded in pixels wherein the two rings of the connecting coupler being used to portray the sequence of data being sent.

6) The new structure in claim 1 including the claim in 5 further comprising a novel process of transforming the 64 bit long DRC into either 32 bit or 128 bit long ones by compressing and elongating the same respectively and involving in the process of compression the removal of the four padded compartments in the top row and splitting the 8 compartments into four each placed one below the other in the middle and bottom rows of the top box and involving in the elongation process enlarging of all the four padded compartments into 24 bit ones in the top row besides retaining the other four compartments of this row as such and the changing of the middle row of top box into 16 compartments of 8 bits each and eliminating the bottom row of the top box totally after transferring the RINDs therein to the new 8 additional compartments created in the second row of the 128 bit DRC.

7) The new structure in claim 1 including the method in claim 4 still further comprising a switching technology initiated by forwarding to start with from the source host, highlighting its next immediate neighbour exchange namely RIND of GE or LE, as the case may be, choosing the detail from the second or third—when there being no GR—compartment (from right end) of the middle row of top box and forwarding the DRC to that exchange and the concerned exchange accepting the DRC on mapping the RIND carried by the DRC with its own RIND on the DRC touching it and accepting the DRC and at that very instant the RIND so far highlighted fading away instantly from the right end compartment of the top row while the next RIND of the subsequent exchange getting highlighted from the third or fourth compartment of the middle row into that end compartment of the top row, a process called in this invention as instant fading-flash highlighting of RINDs', and then the GE or LE on seeing this RIND of the next exchange forwarding the DRC towards that interface for further forwarding to that exchange and this process getting repeated in all the subsequent exchanges one after another thereby exhausting all RINDs in middle and bottom rows till the destination host being reached and further comprising the destination end host accepting the DRC and bringing the communication to an end by decrypting the data using the camouflage developed in the secret process of this invention for using the data.

8) The new structure with improved technologies in claim 1 for computer communications and data transfers substantially as hereinabove described in the specification and illustrated in the accompanying drawings.
